(19) United States
(12) Patent Application Publication
(10) Pub. No.: US 2010/0235064 A1
(43) Pub. Date: Sep. 16, 2010

(54) ASSISTANCE DEVICE FOR UPHILL MOVEMENTS OF AN AUTOMOBILE

(75) Inventors: Mickael Mallet, Montigny-Le-Bretonneux (FR); Alessandro De Rinaldis, Paris (FR); Richard Pothin, Jouars-Pontchartrain (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT s.a.s., Boulogne-Billancourt (FR)

(21) Appl. No.: 12/681,379

(22) PCT Filed: Aug. 19, 2008
(86) PCT No.: PCT/FR08/51507

§ 371 Date: May 27, 2010

(30) Foreign Application Priority Data
Oct. 3, 2007 (FR) 0706917

(51) Int. Cl. B60T 7/12; G06F 19/00

(52) U.S. Cl. 701/70

(57) ABSTRACT

An assistance device for uphill movements of an automobile, including a first assistance calculator controlling a parking brake and automatically controlling release thereof when it is activated and when driving torque transmitted by a clutch is higher than a minimum threshold for maintaining the vehicle on a slope, a second assistance calculator controlling the driving brake and automatically controlling and maintaining its activation when it has been activated, when it is determined that the vehicle is immobile and when the clutch torque is lower than the minimum threshold, and automatically controlling the release thereof when it is activated and when the clutch torque is higher than the threshold, and a mechanism determining immobility of the vehicle, estimating the clutch torque, estimating the slope, and calculating a threshold.

The invention relates to an assistance device for uphill maneuvers of an automobile.

One field of application of the invention is road vehicles provided with a parking brake to allow hill starting.

On current vehicles, hill starting is a source of stress for the user who seeks as far as possible to limit the backward movement of the vehicle.

The document FR-A-2 828 450 describes an assistance device comprising a means for controlling the release of the mechanical brakes of the vehicle which act on wheels of the vehicle, so that the vehicle stays maintained on the slope in a hill maneuver without the driver having to act on this maintaining condition.

It is vitally important for the vehicle to be released at the right moment in order to avoid backward movement or restraint when starting.

The invention aims to provide an assistance device that enhances driving comfort and appeal in an uphill start.

To this end, a first subject of the invention is an assistance device for uphill maneuvers of an automobile, the automobile comprising a drive train clutch for driving the automobile, a first parking brake, which can be actuated via a first interface by the user, and a second vehicle driving brake, which can be actuated via a second interface by the user, for activating them and releasing them, characterized in that the device comprises:

a first assistance computer controlling the first parking brake, comprising an automatic means of commanding the release of the first parking brake, when both the first parking brake is activated via the first interface and the driving torque transmitted by the vehicle clutch is greater than a minimum threshold for maintaining the vehicle on the slope,

a second assistance computer controlling the second driving brake, comprising an automatic means for controlling the maintaining of the activation of the second driving brake when, at the same time, the second driving brake has been activated via the second interface, it has been determined that the vehicle is immobile and the torque transmitted by the vehicle clutch is less than the minimum threshold for maintaining the vehicle on the slope, an automatic means for controlling the release of the second driving brake when both the second driving brake is activated and the torque transmitted by the vehicle clutch is greater than the minimum threshold for maintaining the vehicle on the slope,

a means of determining the immobility of the vehicle, a means of estimating the torque transmitted by the vehicle clutch, a means of estimating the slope, a means of calculating the minimum threshold for maintaining the vehicle on the slope at least according to the slope.

According to other characteristics of the invention,

The means for estimating the torque transmitted by the vehicle clutch is implemented on just one, the first or the second, of said assistance computers, a means of sending the estimated value of this torque to, respectively, the second or first computer being provided.

The means of estimating the slope is implemented on just one, the first or second, of said assistance computers, a means of sending the estimated value of the slope to, respectively, the second or first computer being provided.

The means of estimating the slope is implemented in the form of an inclinometer on the first assistance computer.

Or the means of estimating the slope is implemented in the form of a means of calculating slope as a function of a measurement of longitudinal acceleration on the second assistance computer.

The means of calculating the minimum threshold for maintaining the vehicle on the slope is implemented on just one, the first or second, of said assistance computers, a means of sending the estimated value of the minimum threshold to, respectively, the second or first computer being provided.

Or the means of calculating the minimum threshold for maintaining the vehicle on the slope is implemented on each first and second assistance computer, in association with its automatic release controlling means.

The means of estimating the torque transmitted by the vehicle clutch is linked, externally from the computers, to a sensor sensing the position of a control member of the clutch, according to which said torque is estimated.

The first parking brake is mechanical and the second driving brake is hydraulic.

The second assistance computer, its automatic means of controlling the maintaining of the activation of the second driving brake and its automatic means of controlling the release of the second driving brake, form part of an electronic device for controlling the hydraulic pressures of a hydraulic actuator for controlling the second driving brake.

The invention will be better understood upon reading the following description, given solely as a nonlimiting example with reference to the appended drawings, in which:

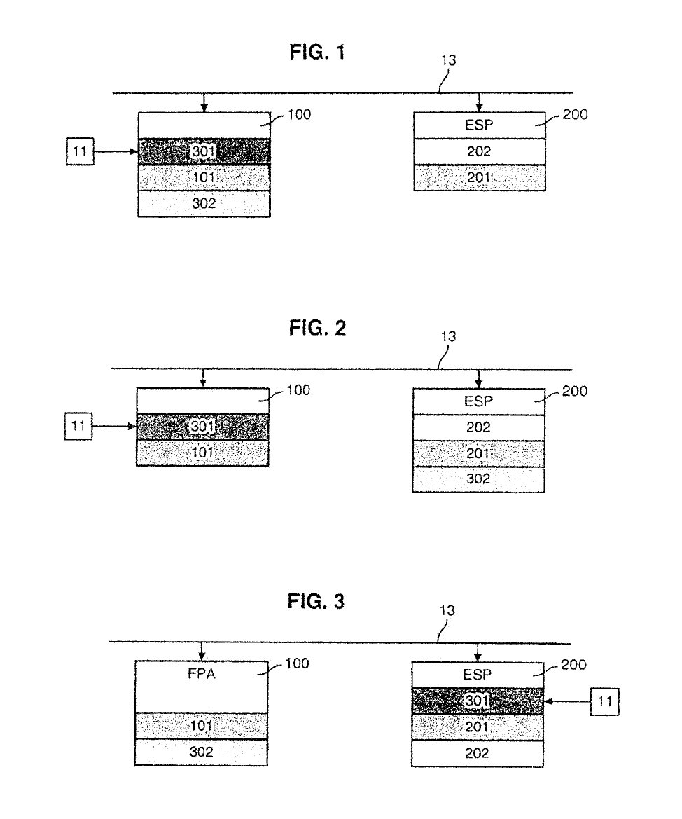

FIGS. 1, 2, 3 and 4 respectively represent first, second, third and fourth embodiments of the device,

FIG. 5 is a block diagram of a vehicle equipped with an assistance device for uphill maneuvers according to the invention.

The invention is described hereinbelow for an automobile with wheels 4, comprising a drive train or engine 1, for example an internal combustion engine, connected by its outlet shaft to a clutch 2 whose outlet shaft is connected to the primary shaft of a gearbox 3 whose secondary shaft is connected in a known manner to the driving wheels of the vehicle. A braking system 5 acts on the wheels 4, for example on the driving wheels or other wheels of the vehicle. The drive train or engine 1 is controlled by means of an accelerator pedal 10 or any other suitable means at the discretion of the user or a central control member 14 connected by a signaling bus 13 in the vehicle, such as a CAN bus for example. The clutch 2 cooperates with a declutching member 11 which can be a clutch pedal operated by the user or an actuator that can be controlled from the bus 13 by the central control member 14 of the vehicle. The gearbox 3 cooperates with a gear-shifting control member 12, such as for example a gear lever operated by the user or an automatic gear-shifting member controlled from the bus 13 by the central control member 14.

The braking system 5 comprises a parking brake 51 and a driving brake 52 of the vehicle.

The brake 51 can be actuated by the user via a first interface 53, which can be, for example, a so-called “handbrake” handle, acting on an actuator 54 to activate and release the brake 51. The parking brake 51 is, for example, mechanical.

The vehicle driving brake 52 is the one designed to slow down the vehicle when traveling. The driving brake 52 is also called service brake. The driving brake 52 can be actuated by the user via a second interface 55, which can be, for example, the brake pedal, acting on an actuator 56 to activate and release the brake 52. The driving brake 52 is, for example, hydraulic.

The assistance device comprises a first assistance computer 100 controlling the first parking brake 51 (called assisted parking brake module, or FPA module), linked to its actuator 54 to send it commands to activate or release the brake 51.

The assistance device comprises a second assistance computer 200 controlling the second driving brake 52 (hill start assist, or HSA module), separate from the first computer 100 and linked to its actuator 56 to send it commands to activate or release the brake 52. In the case where the brake 52 is hydraulic, the hydraulic pressures are controlled.

The first assistance computer 100 controlling the first parking brake 51 comprises an automatic means 101 of controlling the release of the first parking brake (called FPA release module), when both the parking brake 51 has been activated via the first interface 53 and the driving torque C transmitted by the vehicle clutch 2 is greater than a minimum threshold Cmin for maintaining the vehicle on the slope. Such an assistance computer controlling the parking brake 51 is described, for example, in the patent application FR-A-2 828450, which is incorporated for reference in this patent application.

The second assistance computer 200 controlling the second driving brake 52 comprises an automatic means 202 of controlling the maintaining of the activation of the driving brake 52 when at the same time the driving brake 52 has been activated via the second interface 55, it has been determined that the vehicle is immobile and the torque C transmitted by the vehicle clutch 2 is less than the minimum threshold Cmin for maintaining the vehicle on the slope.

The second assistance computer 200 controlling the second driving brake 52 also comprises an automatic means 201 of controlling the release of the driving brake 52 (called HSA release module), when at the same time the driving brake 52 is activated and the torque C transmitted by the vehicle clutch 2 is greater than the minimum threshold Cmin for maintaining the vehicle on the slope.

The second assistance computer 200 controlling the second driving brake 52 is, for example, implemented on an ESP system.

In one embodiment, the second assistance computer 200, its automatic means 202 of controlling the maintaining of the activation of the driving brake 52 and its automatic means 201 of controlling its release, form part of an electronic device for controlling the hydraulic pressures of the hydraulic actuator 56 for controlling the driving brake 52.

The assistance device also comprises a means 301 of estimating the torque transmitted by the vehicle clutch (so-called learning module) and a slope estimation means 302.

A means of calculating the minimum threshold Cmin for maintaining the vehicle on the slope at least according to the slope is also provided.

The device can be incorporated in an overall system whose hardware architecture comprises a hydraulic braking block of conventional ESP type with which to control the pressures on each stirrup and which is equipped at least with a master cylinder pressure sensor, an assisted parking brake system (FPA) including the actuator and the computer, a measurement of the slope, of the engine speed, of the wheel speed, of the positions of the accelerator and clutch pedals, information on the type of gear ratio engaged (forward, reverse, neutral).

The device comprises two systems embedded on the vehicle:

The FPA 100 which immobilizes the vehicle upon an action on the part of the user and which corresponds to the parking brake. When the parking brake is activated, the FPA 100 also fulfills an uphill start assistance function, by releasing the parking brake at the right moment.

The HSA 200 is also an uphill start assistance function, but the latter is automatically tripped when the vehicle is stopped by maintaining the brake pressure exerted by the user. The brake pressure must also be released at the right moment.

The learning module 301 estimates the torque C transmitted by the clutch, for example by learning the characteristic of the clutch and by using the position of the member 11 or clutch pedal.

In one embodiment, the HSA function release module 201 is encoded in the ESP computer.

In one embodiment, the computer, whether the FPA computer 100 or the HSA and/or ESP computer 200, which handles the learning 301 of the clutch characteristic is linked by wire, and therefore not by the bus 13, to the sensor sensing the position of the member 11 or clutch pedal.

In one embodiment, for learning, an injection computer supplies other information via the bus 13.

The release module, whether the FPA module 101 or the HSA module 201, requires the estimated torque C passing through the clutch 2. This torque C is calculated in the learning module 301.

In one embodiment, the release module 101, 201 also uses information that exists on the bus 13, such as, for example, the gear engaged, and the slope.

In the embodiment of FIG. 1, the learning 301 is implemented in the FPA module 100 and the inclinometer 302 of the FPA 100 is used to measure the slope. In this case, the interchanges over the bus 13 between the FPA 100 and the HSA 200 are as follows: from FPA 100 to HSA 200: the slope and the estimated torque C.

In the embodiment of FIG. 2, the learning 301 is implemented in the FPA module 100 and the longitudinal accelerometer 302 of the HSA 200 is used to measure the slope. In this case, the interchanges over the bus 13 between the FPA 100 and the HSA 200 are as follows:

from HSA 200 to FPA 100: the slope,

from FPA 100 to HSA 200: the estimated torque C.

In the embodiment of FIG. 3, the learning 301 is implemented in the HSA module 200 and the inclinometer 302 of the FPA 100 is used to measure the slope. In this case, the interchanges over the bus 13 between the FPA 100 and the HSA 200 are as follows:

from HSA 200 to FPA 100: the estimated torque C,

from FPA 100 to HSA 200: the slope.

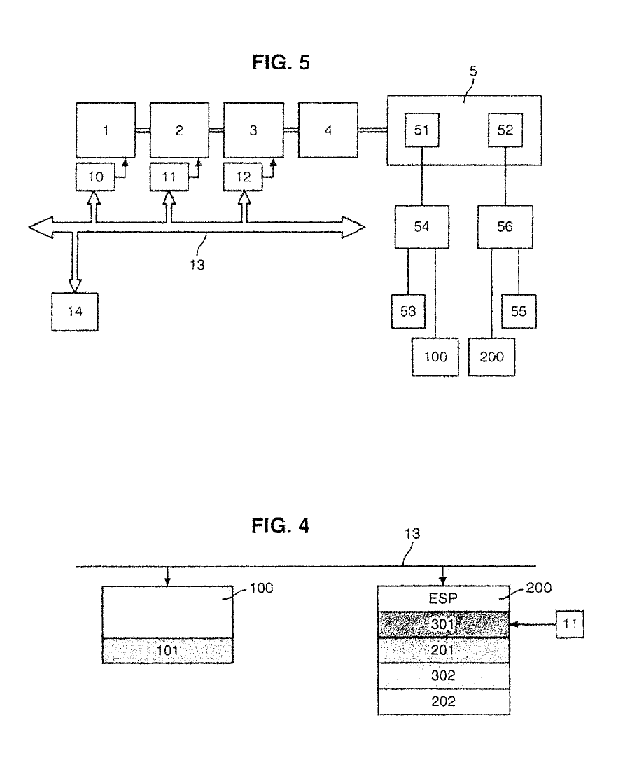

In the embodiment of FIG. 4, the learning 301 is implemented in the HSA module 200 and the longitudinal accelerometer 302 of the HSA 200 is used to measure the slope. In this case, the interchanges over the bus 13 between the FPA 100 and the HSA 200 are as follows: from HSA 200 to FPA 100: the slope and the estimated torque C.

The device is preferentially implemented in the form of a program installed and run on the computers.

One advantage is that the redundancy of functions can be exploited to optimize the distribution of the computer code and/or of the sensors, for example by using the inclinometer of the FPA to supply the slope information to the HSA, which no longer requires any module incorporating the longitudinal accelerometer, or by using the information from the clutch travel sensor for both services without duplicating the sensor.

Another advantage is minimizing the service difference between the brakes 51, 52 by using the same signals and by sharing certain software modules.

Another advantage is avoiding the malfunctions due to poor interaction between the two FPA and HSA systems.

1-10. (canceled)

11. An assistance device for uphill maneuvers of an automobile, the automobile including a drive train clutch for driving the automobile, a first parking brake, which can be actuated via a first interface by a user, and a second vehicle driving brake, which can be actuated via a second interface by the user, for activating them and releasing them, the device comprising:
a first assistance computer controlling the first parking brake, comprising a first automatic means for commanding release of the first parking brake, when both the first parking brake is activated via the first interface and the driving torque transmitted by the vehicle clutch is greater than a minimum threshold for maintaining the vehicle on a slope;
a second assistance computer controlling the second driving brake, comprising a second automatic means for controlling maintaining of activation of the second driving brake when, at a same time, the second driving brake has been activated via the second interface, it has been determined that the vehicle is immobile and the torque transmitted by the vehicle clutch is less than the minimum threshold for maintaining the vehicle on the slope, a third automatic means for controlling the release of the second driving brake when both the second driving brake is activated and the torque transmitted by the vehicle clutch is greater than the minimum threshold for maintaining the vehicle on the slope;
a means for determining immobility of the vehicle;
a means for estimating the torque transmitted by the vehicle clutch;
a means for estimating the slope; and
a means for calculating the minimum threshold for maintaining the vehicle on the slope at least according to the slope.

12. The device as claimed in claim 11, wherein
the means for estimating the torque transmitted by the vehicle clutch is implemented on just one of the first or the second assistance computers, and further comprising means for sending the estimated value of this torque to, respectively, the second or first assistance computer being provided.

13. The device as claimed in claim 11, wherein
the means for estimating the slope is implemented on just one of the first or second assistance computers, and further comprising means for sending the estimated value of the slope to, respectively, the second or first assistance computer being provided.

14. The device as claimed in claim 11, wherein
the means for estimating the slope is implemented in a form of an inclinometer on the first assistance computer.

15. The device as claimed in claim 11, wherein
the means for estimating the slope is implemented in a form of a means for calculating the slope as a function of a measurement of longitudinal acceleration on the second assistance computer.

16. The device as claimed in claim 11, wherein
the means for calculating the minimum threshold for maintaining the vehicle on the slope is implemented on just one of the first or second assistance computers, and further comprising a means for sending the estimated value of the minimum threshold to, respectively, the second or first assistance computer being provided.

17. The device as claimed in claim 11, wherein
the means for calculating the minimum threshold for maintaining the vehicle on the slope is implemented on each of the first and second assistance computers, in association with its automatic release controlling means.

18. The device as claimed in claim 11, wherein
the means for estimating the torque transmitted by the vehicle clutch is linked, externally from the first and second assistance computers, to a sensor sensing the position of a control member of the clutch, according to which the torque is estimated.

19. The device as claimed in claim 11, wherein
the first parking brake is mechanical and the second driving brake is hydraulic.

20. The device as claimed in claim 11, wherein
the second assistance computer, its second automatic means for controlling the maintaining of the activation of the second driving brake, and its third automatic means for controlling the release of the second driving brake, form part of an electronic device for controlling the hydraulic pressures of a hydraulic actuator for controlling the second driving brake.
